(19) United States
(12) Patent Application Publication
(10) Pub. No.: US 2019/0228345 A1
(43) Pub. Date: Jul. 25, 2019

(54) VEHICLE SHARING SYSTEM AND METHOD

(71) Applicant: GENERAL MOTORS LLC, Detroit, MI (US)

(72) Inventors: Christopher L. Oesterling, Troy, MI (US); Aditya S. Kamini, Bloomfield Hills, MI (US); Devin Lawrence Bingle, Saint Clair Shores, MI (US)

(21) Appl. No.: 15/875,915

(22) Filed: Jan. 19, 2018

(51) Int. Cl. G06Q 10/02; G08G 1/14

(52) U.S. Cl. CPC G06Q 10/02; G06Q 30/0645; G08G 1/14

(57) ABSTRACT

A vehicle sharing system and method, the method comprising the steps of: receiving an active vehicle sharing notification that indicates a shared vehicle is to be used, determining a third-party reservation availability that indicates a vehicle sharing parking space that was occupied by the shared vehicle will be available for a rental period, sending a vehicle sharing parking space availability to a third party, and receiving a notification of use of the vehicle sharing parking space during the rental period of the third-party reservation availability.

### INTRODUCTION

The disclosure relates to parking management for vehicle sharing systems and methods.

Vehicle sharing systems allow individuals to rent vehicles, typically for limited periods of time (e.g., per hour rentals). Individuals can make reservations for station-based, round-trip or one-way use of a variety of vehicles, oftentimes located in or around major cities. The shared vehicles, for pickup and return, are usually located at reserved parking spaces identified with permanently mounted signage. The present methods and systems help coordinate use of the vehicle sharing parking spaces during rental periods.

### SUMMARY

According to a first embodiment, there is provided a method of managing a vehicle sharing system. The method includes the steps of receiving an active vehicle sharing reservation notification, wherein the active vehicle sharing reservation notification indicates that a shared vehicle is to be used; determining a third-party reservation availability, wherein the third-party reservation availability indicates that a vehicle sharing parking space that was occupied by the shared vehicle will be available for a rental period; sending a vehicle sharing parking space availability notification to a third party; and receiving a notification of use of the vehicle sharing parking space during the rental period of the third-party reservation availability.

According to other embodiments, there is provided that of the first embodiment, further including any one or more of the following:
further comprising the step of confirming that the shared vehicle has departed from the vehicle sharing parking space;
wherein the active vehicle sharing reservation notification is received in response to a station-based, round-trip rental of the shared vehicle;
wherein the third party is affiliated with the vehicle sharing parking space;
further comprising the step of monitoring the vehicle sharing parking space during the rental period;
wherein a mobile device of the third party is used to monitor the vehicle sharing parking space during the rental period;
wherein a radio frequency identification (RFID) sensor associated with a third-party vehicle is used to monitor the vehicle sharing parking space during the rental period;
further comprising the step of reconciling usage of the vehicle sharing parking space between the shared vehicle and the third party;
wherein the step of reconciling usage of the vehicle sharing parking space includes sending a notification to a shared vehicle driver of the shared vehicle that the vehicle sharing parking space is unavailable;
wherein the notification sent to the shared vehicle driver that the vehicle sharing parking space is unavailable includes an alternative parking location suggestion;
wherein the vehicle sharing parking space availability notification includes a location of the vehicle sharing parking space, a parking maximum duration, and a cost of a third-party rental;
wherein a shared vehicle driver of the shared vehicle is associated with a shared vehicle driver profile;
wherein the shared vehicle driver profile is built by monitoring habits of the shared vehicle driver;
wherein the habits of the shared vehicle driver include prior rentals of a shared vehicle by the shared vehicle driver; and
wherein the shared vehicle driver profile is used to determine a parking maximum duration of the vehicle sharing parking space availability notification.

According to a second embodiment, there is provided a method of managing a vehicle sharing system, comprising the steps of: confirming that a shared vehicle has departed from a vehicle sharing parking space; determining a third-party reservation availability, wherein the third-party reservation availability indicates that a vehicle sharing parking space that was occupied by the shared vehicle will be available for a rental period; determining whether the rental period of the third-party reservation availability is greater than a threshold period; when it is determined that the rental period of the third-party reservation availability is greater than the threshold period, sending a vehicle sharing parking space availability notification to a third party; monitoring the vehicle sharing parking space; and reconciling usage of the vehicle sharing parking space between the shared vehicle and the third party.

According to a third embodiment, there is provided a vehicle sharing system, comprising: a shared vehicle; a vehicle sharing parking space; a reservation profile building tool configured to receive an active vehicle sharing reservation notification and build a reservation profile; and a reservation management tool configured to determine a third-party reservation availability that indicates that the vehicle sharing parking space will be available for a rental period, send a vehicle sharing parking space availability notification to a third party so that the third party can use the vehicle sharing parking space during at least a part of the rental period of the shared vehicle, and receive a notification of use of the vehicle shared parking space during the rental period of the third-party reservation availability.

According to other embodiments, there is provided that of the third embodiment, further including any one or more of the following:
wherein the reservation profile building tool is further configured to monitor habits of a shared vehicle driver, develop a shared vehicle driver profile, and modify the reservation profile using the shared vehicle driver profile; and
wherein the habits of the shared vehicle driver include prior rentals of a shared vehicle by the shared vehicle driver.

Other combinations of features are certainly possible, including combinations of features between various embodiments.

### BRIEF DESCRIPTION OF THE DRAWINGS

Exemplary embodiments will hereinafter be described in conjunction with the appended drawings, wherein like designations denote like elements, and wherein:

FIG. 1 is a block diagram schematically illustrating an embodiment of a vehicle sharing system that is capable of utilizing the methods disclosed herein;

FIG. 2 is a flowchart illustrating a method of managing a vehicle sharing system; and

FIG. 3 is a flowchart illustrating substeps of a step of the method illustrated in FIG. 2.

### DETAILED DESCRIPTION

The system and methods below enable more efficient and economical use of parking spaces in a vehicle sharing system. Vehicle sharing systems oftentimes pay for dedicated parking spaces (stations) for shared vehicles. Given that parking in major cities is expensive, optimizing usage of the vehicle sharing parking spaces is desirable and can help increase revenue. Accordingly, when shared vehicles are being used for active reservations, the parking spaces will normally be unoccupied and can potentially be reserved for a specified duration to third party customers needing parking spaces. The systems and methods described herein can help effectively manage the resources of a vehicle sharing system by, in some embodiments, reconciling usage of vehicle sharing parking spaces and may use additional information particular to the shared vehicle driver in order to do so.

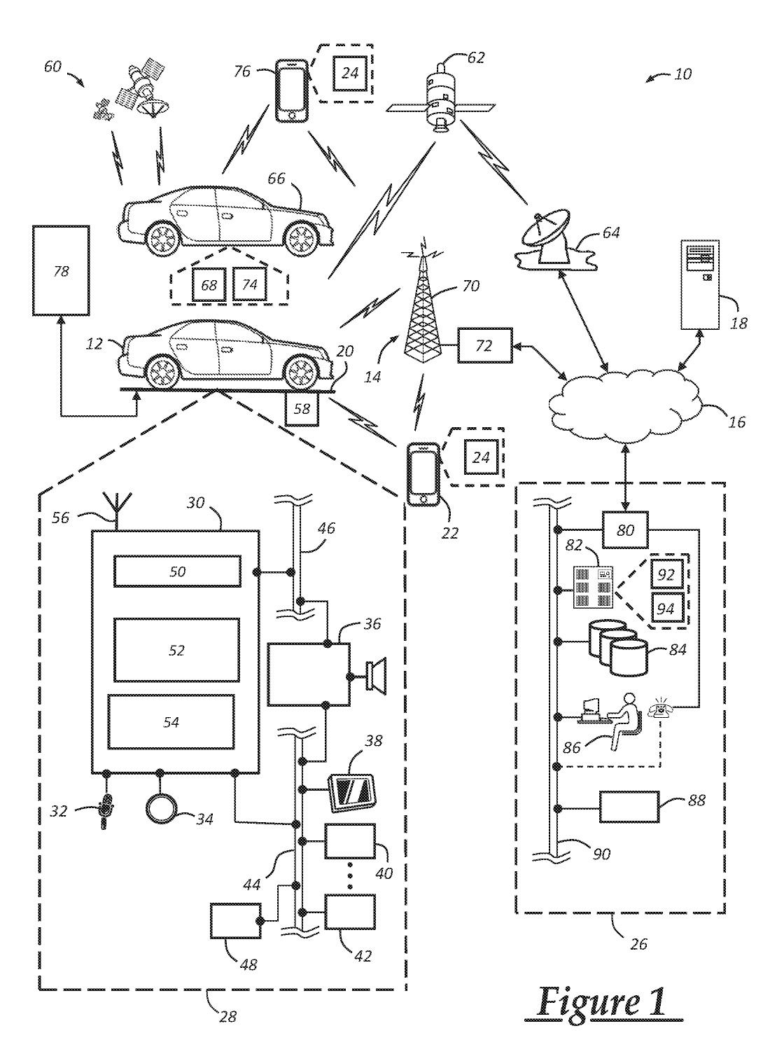

With reference to FIG. 1, there is shown an operating environment that comprises a vehicle sharing system 10 that can be used with the methods disclosed herein. Vehicle sharing system 10 generally includes a shared vehicle 12, one or more wireless carrier systems 14, a land communications network 16, a computer 18, and a vehicle sharing parking space 20. A user of the shared vehicle 12 may have a mobile device 22 and a vehicle sharing application 24 installed on the mobile device 22 to help coordinate rentals. It should be understood that the disclosed method can be used with any number of different systems and is not specifically limited to the operating environment shown here. For example, key fob based systems or other ways to rent the shared vehicle 12 may be employed. Also, the architecture, construction, setup, and operation of the system 10 and its individual components are generally known in the art. Thus, the following paragraphs simply provide a brief overview of one such vehicle sharing system 10; however, other system configurations are certainly possible, and systems not shown here could employ the disclosed methods as well.

Shared vehicle 12 is depicted in the illustrated embodiment as a passenger car, but it should be appreciated that any other vehicle including motorcycles, trucks, sports utility vehicles (SUVs), recreational vehicles (RVs), marine vessels, etc., can also be used. Some of the vehicle electronics 28 is shown generally in FIG. 1 and includes a telematics unit 30, a microphone 32, one or more pushbuttons or other control inputs 34, an audio system 36, a visual display 38, a GPS module 40, as well as a number of other vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is itself a vehicle system module (VSM) and can be implemented as an OEM-installed (embedded) or aftermarket device installed in the shared vehicle that enables wireless voice and/or data communication over wireless carrier system 14 and via wireless networking. This enables the shared vehicle to communicate with the shared vehicle application 24 or a call center 26, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the shared vehicle 12 to offer a number of different features or services including those related to navigation, telephony, emergency assistance, diagnostics, infotainment, etc. Data can be sent either via a data connection, such as via packet data transmission over a data channel, or via a voice channel using techniques known in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit 30 can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services.

Telematics unit 30 can be used to provide a diverse range of vehicle services that involve wireless communication to and/or from the vehicle. Such services may include transmission of notifications from the vehicle sharing application 24 or the call center 26 regarding the rental of shared vehicle 12 or usage of the vehicle sharing parking space 20, or turn-by-turn directions and other navigation-related services that are provided in conjunction with the GPS-based vehicle navigation module 40, to cite two examples. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 is a VSM which receives radio signals from a constellation 60 of GPS satellites. From these signals, the module 40 can determine vehicle position that is used for providing navigation and other position-related services to the vehicle driver or an entity monitoring the position of the shared vehicle 12. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 26 or other remote computer system, such as computer 18, for other purposes, such as fleet management and/or reservation management. Also, new or updated map data can be downloaded to the GPS module 40 from the call center 26 via the telematics unit 30.

In addition to GPS module 40, the shared vehicle may include a position sensor 48, which can interact with another position sensor 58 associated with the vehicle sharing parking space 20. The position sensor 48 may be a radio frequency identification (RFID) reader and antenna that interacts with an RFID tag 58. Accordingly, when the RFID tag 58 is within the range of the shared vehicle 12, the RFID reader and antenna 48 associated with the shared vehicle can activate the tag.

The shared vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, and another VSM 42 can be a powertrain control module that regulates operation of one or more components of the vehicle powertrain. As is appreciated by those skilled in the art, the above-mentioned VSMs are only examples of some of the modules that may be used in shared vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Various other vehicle user interfaces can also be utilized in conjunction with other VSMs, as the interfaces of FIG. 1 are only an example of one particular implementation.

The mobile device 22 of the shared vehicle driver may interact with the shared vehicle 12, such as via the telematics unit 30, or with the wireless carrier system 14. The mobile device 22 can include computer processing capability, a transceiver capable of communicating using a short-range wireless protocol, and a visual mobile device display. The mobile device 22 also includes one or more microprocessors that execute machine code to generate logical output, such as output relating to the shared vehicle application 24. Examples of the mobile device 22 include the iPhone manufactured by Apple and the Galaxy manufactured by Samsung, as well as others. While the mobile device 22 may include the ability to communicate via cellular communications using the wireless carrier system 14, this is not always the case. For instance, Apple manufactures devices such as the various models of the iPad and iPod Touch that include the processing capability, a display, and the ability to communicate over a short-range wireless communication link. However, the iPod Touch™ and some iPads™ do not have cellular communication capabilities. Even so, these and other similar devices may be used or considered a type of wireless device, such as the mobile device 22, for the purposes carrying out one or more steps of the methods described herein.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the shared vehicle 12. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the shared vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 26. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 26 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a client computer used by the shared vehicle driver or other subscriber for such purposes as accessing or receiving vehicle data or to setting up or configuring subscriber preferences or otherwise controlling shared vehicle features; or a third-party repository to or from which vehicle data or other information is provided, whether by communicating with the shared vehicle 12 or call center 26, or both. A computer 18 can also be used for providing Internet connectivity such as DNS services or as a network address server that uses DHCP or other suitable protocol to assign an IP address to the shared vehicle 12.

Call center 26 is a back-end facility designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

Server 82 may include a software framework for accommodating reservation profile building tool 92 and a reservation management tool 94. While these tools are schematically shown as being separate in FIG. 1, it is possible for one software framework or platform to execute both profile building and reservation management, and accordingly, the reservation profile building tool 92 and the reservation management tool 94 would be executed via the same platform. Similarly, it is possible for the reservation profile building tool 92 and the reservation management tool 94 to be executed via separate servers or processing devices, even those remote from the call center 26. For example, it is possible for the reservation profile building tool 92 and/or the reservation management tool 94 to be cloud- or web-based systems that are part of the vehicle sharing application, or implemented in some other operable format.

Database 84 may be a vehicle information database that stores information relating to habits of shared vehicle drivers for use with the present systems and methods. Database 84 can store vehicle sharing system account information such as subscriber authentication information, profile records, behavioral patterns, and other information. As with server 82, it is possible for the database 84 to be implemented in other operable fashions, such as a cloud- or web-based system that is not directly related to the call center 26. Further, it is possible for the methods and systems herein to extract vehicle or driver information from a number of discrete databases.

Server 82 and its database 84 may be implemented in a known manner using an electronic processor with non-transitory computer readable memory storing program code that, upon execution by the processor, carries out the methods described herein, and with that same memory or a separate non-transitory computer readable memory used as database 84 to store the data used in the methods described herein, such as shared vehicle driver profiles and reservation profiles, which are described in greater detail below. The server 82 may thus be configured as a special purpose analyzer that includes the reservation profile building tool 92 and the reservation management tool 94, both of which may be implemented using the processor operating under control of the program code to provide a system that carries out some or all of the steps of method 200 described below.

The vehicle sharing system 10 may interact with one or more third parties, such as a third party that operates a third-party vehicle 66 or a third-party parking service 78 that is associated with the vehicle sharing parking space 20. A user of the third-party vehicle 66 may have a mobile device 76, which, similar to the mobile device 22, may include the vehicle sharing application 24. Also, similar to the shared vehicle 12, the third-party vehicle 66 may include a position sensor 68 and/or a GPS module 74 which operate in a similar fashion to the position sensor 48 and the GPS module 40, respectively, of the shared vehicle 12. Accordingly, in one embodiment the position sensor 68 may be an RFID reader configured to interact with the RFID tag 58 associated with the shared parking space 20.

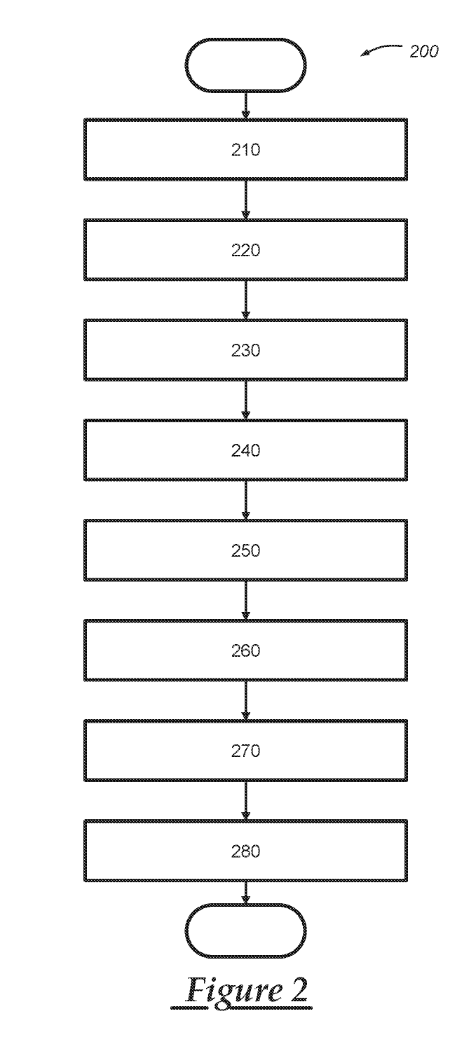

With reference to FIG. 2, there is shown an embodiment of a method 200 of managing parking for a vehicle sharing system. The method 200 may be used to offset the expense of parking rental fees by allowing third parties to use vehicle sharing parking spaces during rental periods. In some embodiments, the method can more efficiently estimate rental periods by taking into account habits of the shared vehicle driver. While the method 200 is described in conjunction with the vehicle sharing system 10 of FIG. 1, it is possible for one or more embodiments of the method 200 to be used with other implementations of a vehicle sharing system.

The method begins at step 210 with receiving an active vehicle sharing reservation notification. The active vehicle sharing reservation notification indicates that shared vehicle 12 is to be used. The active vehicle sharing reservation may be accomplished via the vehicle sharing application 24 or by any other operable means. For example, a subscriber of the vehicle sharing system 10 may use his or her mobile device 22 to request use of a shared vehicle via the vehicle sharing application 24. The active vehicle sharing reservation notification may be received by the computer 18, the call center 26, or another entity. In some embodiments, the active vehicle sharing reservation notification may be received in response to a station-based, round-trip rental of the shared vehicle 12. However, other rental types are certainly possible, such as one-way sharing where the shared vehicle 12 may be dropped off at an alternate location than the vehicle sharing parking space 20.

Step 220 of the method involves confirming that the shared vehicle 12 has departed from the vehicle sharing parking space 20. This step can be accomplished in a multitude of ways. In one example, the position sensors 48, 58 are used to confirm that the shared vehicle 12 has departed from the vehicle sharing parking space 20. If the position sensor 48 is an RFID reader and position sensor 58 is an RFID tag, an indication that the RFID tag 58 is no longer within range of the RFID reader 48 may indicate that the shared vehicle 12 has departed. In another embodiment, a reading from the GPS module 40 may be used to confirm that the shared vehicle 12 has departed from the vehicle sharing parking space 20. In yet another embodiment, location-based tracking from the mobile device 22 and/or the vehicle sharing application 24 may be used to confirm that the shared vehicle 12 has departed from the vehicle sharing parking space 20. In yet another embodiment, activation of a shared vehicle key fob may confirm that the vehicle 12 has departed from the vehicle sharing parking space 20. In some embodiments, the active vehicle sharing reservation notification may not be sent or received (step 210) until it is confirmed that the shared vehicle 12 has departed from the vehicle sharing parking space 20. Other embodiments are certainly possible.

Step 230 of the method involves building a reservation profile. The reservation profile may provide information relating to a rental period in which the shared parking space 20 will likely be available. The reservation profile may be automatically built as a function of use of the vehicle sharing application 24, or it may be built and/or estimated by a back-end facility, such as through use of the reservation building tool 92 at the call center 26. The reservation profile may contain information relating to the shared driver's identity, the rental period of the shared vehicle 20, whether the rental is round-trip or one-way, etc.

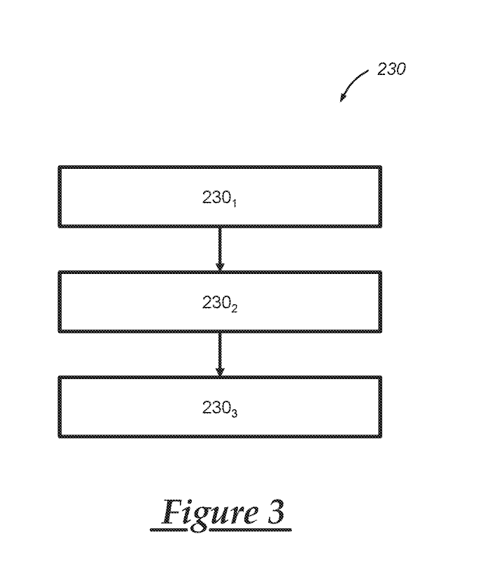

With reference to FIG. 3, in one embodiment of step 230, a shared vehicle driver profile is used to build the reservation profile. This embodiment may help improve the prediction of a third-party reservation availability for the vehicle sharing parking space 20, which will be detailed further below. Substep 230₁ involves monitoring shared vehicle driver habits. If the shared vehicle driver has previously rented a shared vehicle in the shared vehicle system 10, it may be possible to keep track of his or her driving habits via the shared vehicle application 24 and/or via server 82. Monitoring may also take advantage of information from the GPS modules in shared vehicles, such as the GPS module 40 in the shared vehicle 12. Due to the nature of shared vehicle systems, the monitoring step is typically driver-based, not vehicle-based. Substep 230₂ involves developing a shared vehicle driver profile. The shared vehicle driver profile may contain the habits of the shared vehicle driver. For example, if the driver goes to a three-hour long football game every Saturday, this information may be part of the shared vehicle driver profile. In another example, if the driver goes to the gym every Tuesday and Thursday morning, and returns the shared vehicle after two hours, this information may be part of the shared vehicle driver profile. In yet another example, if the shared vehicle driver is consistently late or early when returning the shared vehicle, such information, including a quantitative estimate of how late or early, may be part of the shared vehicle driver profile. Other examples are certainly possible. Substep 230₃ involves modifying the reservation profile using the shared vehicle driver profile. If certain aspects of the reservation profile match the shared vehicle driver profile, it may be useful to modify the reservation profile using information from the shared vehicle driver profile. Continuing with the example above, if the shared vehicle driver requests a new rental of the shared vehicle 12 on Saturday at 2:00 PM for four hours, based on the shared vehicle driver profile, if he always returns his vehicle after three hours, the reservation profile may be adjusted from four hours to three hours, or from four hours to three-and-a-half hours. Again, other examples are certainly possible.

Returning to FIG. 2, step 240 of the method involves determining a third-party reservation availability. The third-party reservation availability indicates that the vehicle sharing parking space 20 that was occupied by the shared vehicle 12 will be available for a rental period. In one embodiment, the reservation management tool 94 may be used to determine the third-party reservation availability. This embodiment many be desirable in instances where the shared vehicle driver profile is used to modify the reservation profile. In some instances, this step may be accomplished automatically with information based on the reservation profile alone (e.g., a three-hour rental of the shared vehicle would equate to a three-hour third-party reservation availability). In other instances, a cushion may be added to the third-party reservation availability to allow for a more seamless transfer between the third-party vehicle 66 and the shared vehicle 12. For example, an extra five, ten, or fifteen minutes may be substracted from the third-party reservation availability to allow for situations in which the shared vehicle 12 is returned a bit early.

Step 240 may also include determining whether the rental period of the third-party reservation availability is greater than a threshold period. This may depend on the particularities of the vehicle sharing system 10. For example, if rentals of the shared vehicle are always at least a half hour, it may be determined that the third-party reservation availability is always greater than a threshold period. Accordingly, the step of determining whether the rental period of the third-party reservation availability is greater than a threshold period will not be a separate calculation step performed with every rental, in this embodiment. In other embodiments, a separate determining step may be performed to make sure that the third-party reservation availability is long enough (e.g., greater than a threshold of fifteen minutes, thirty minutes, forty-five minutes, etc.) to allow for a third-party to use the vehicle sharing parking space 20. In one or more embodiments, step 240 may be accomplished by the reservation management tool 94.

Step 250 involves sending a vehicle sharing parking space availability notification. The vehicle sharing parking space availability notification may be sent to one or more third parties to indicate that the vehicle sharing parking space 20 will be available for parking, such as by the third-party vehicle 66, for a certain period, as dictated by the third-party reservation availability. In some embodiments, the vehicle sharing parking space availability may be sent to other subscribers of the vehicle sharing system 10, and may be sent via the vehicle sharing application 24. In this example, after the shared vehicle 12 has departed from the vehicle sharing parking space 20, the vehicle sharing parking space availability notification may be sent to the third party mobile device 76 via the vehicle sharing application 24. The third-party may accept and rent the parking space 20 for the rental period determined by the third-party reservation availability. In other embodiments, the vehicle sharing parking space notification may be sent to a third-party such as the third-party parking service 78. If, for example, the vehicle sharing parking space 20 is located in a parking garage, the third-party parking service 78 may be an operator of the parking garage, who can then allow a third-party vehicle 66 to park in the space. The vehicle sharing parking space availability notification may include a location of the vehicle sharing parking space, a parking maximum duration (which may be based on the third-party reservation availability), and/or a cost of the third-party rental. In one or more embodiments, step 250 may be accomplished by the reservation management tool 94.

Step 260 involves receiving a notification of use of the vehicle sharing parking space. In response to the vehicle sharing parking space availability notification, the system 10 may receive notification of use of the vehicle sharing parking space 20 during the rental period of the third-party reservation availability. For example, once a third party accepts an offer to park the third-party vehicle 66 in the vehicle sharing parking space 20, a notification may be sent to the vehicle sharing application 24 or the reservation management tool 94. In other embodiments, receiving notification of use of the vehicle sharing parking space 20 may occur when a position sensor, such as the RFID tag 58, is read or otherwise activated. This may allow the system 10 to remove or recall the vehicle sharing parking space availability notification, such that other third parties will not be able to accept the offer to park in the vehicle sharing parking space 20. Additionally, the receipt of the notification of use of the vehicle sharing parking space 20 may be accompanied by a parking fee, credit, or some other form of payment for parking at the vehicle sharing parking space during the rental period.

Step 270 involves monitoring the vehicle sharing parking space. In embodiments where the vehicle sharing parking space availability notification is sent to third-parties via an application program on a mobile device, such as via the vehicle sharing application 24 on mobile device 76, the mobile device itself may be used to monitor the vehicle sharing parking space 20. For example, if a third party parks, leaves the vehicle 66, and does not return to the vehicle, it may be determined that the third-party vehicle 66 is still parked in the vehicle sharing parking space 20. In other embodiments, the position sensors 58, 68 may be used to monitor the vehicle sharing parking space 20. For example, if the position sensor 68 on the third-party vehicle 66 is an RFID reader, it may be able to read an RFID tag 58 at the vehicle sharing parking space 20. In yet other embodiments, the monitoring step may be performed by the third-party parking service 78 or some other entity. Other examples are possible.

Step 280 involves reconciling vehicle sharing parking space usage. This step may be necessary in instances where the third-party vehicle 66 is parked in the vehicle sharing parking space 20 when the shared vehicle 12 returns from a rental. Step 280 may include sending a notification to the driver of the shared vehicle 12 that the shared vehicle parking space 20 is unavailable. This notification may include an alternative parking location suggestion instructing the driver of the shared vehicle 12 to park at another vehicle sharing parking space that is available. In some instances, this step may be accomplished by monitoring the position of the shared vehicle 12, such as via the mobile device 22 and/or the GPS module 40. Once the shared vehicle 12 is within some threshold distance (e.g., five miles) and the third-party vehicle 66 is still in the vehicle sharing parking space 20, a notification may be sent to the driver of the shared vehicle 12 that the space is unavailable. It is also possible to use the shared vehicle driver profile in step 280 if it was not accounted for in step 240, to help better predict whether there will be a conflict between the third-party vehicle 66 and the shared vehicle 12.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive or. As an example, the phrase “A, B, and/or C” includes: “A”; “B”; “C”; “A and B”; “A and C”; “B and C”; and “A, B, and C.”

1. A method of managing a vehicle sharing system, comprising the steps of:
receiving an active vehicle sharing reservation notification, wherein the active vehicle sharing reservation notification indicates that a shared vehicle is to be used;
determining a third-party reservation availability, wherein the third-party reservation availability indicates that a vehicle sharing parking space that was occupied by the shared vehicle will be available for a rental period;
sending a vehicle sharing parking space availability notification to a third party; and
receiving a notification of use of the vehicle shared parking space during the rental period of the third-party reservation availability.

2. The method of claim 1, further comprising the step of confirming that the shared vehicle has departed from the vehicle sharing parking space.

3. The method of claim 1, wherein the active vehicle sharing reservation notification is received in response to a station-based, round-trip rental of the shared vehicle.

4. The method of claim 1, wherein the third party is affiliated with the vehicle sharing parking space.

5. The method of claim 1, further comprising the step of monitoring the vehicle sharing parking space during the rental period.

6. The method of claim 5, wherein a mobile device of the third party is used to monitor the vehicle sharing parking space during the rental period.

7. The method of claim 5, wherein a radio frequency identification (RFID) sensor associated with a third-party vehicle is used to monitor the vehicle sharing parking space during the rental period.

8. The method of claim 1, further comprising the step of reconciling usage of the vehicle sharing parking space between the shared vehicle and the third party.

9. The method of claim 8, wherein the step of reconciling usage of the vehicle sharing parking space includes sending a notification to a shared vehicle driver of the shared vehicle that the vehicle sharing parking space is unavailable.

10. The method of claim 9, wherein the notification sent to the shared vehicle driver that the vehicle sharing parking space is unavailable includes an alternative parking location suggestion.

11. The method of claim 1, wherein the vehicle sharing parking space availability notification includes a location of the vehicle sharing parking space, a parking maximum duration, and a cost of a third-party rental.

12. The method of claim 1, wherein a shared vehicle driver of the shared vehicle is associated with a shared vehicle driver profile.

13. The method of claim 12, wherein the shared vehicle driver profile is built by monitoring habits of the shared vehicle driver.

14. The method of claim 13, wherein the habits of the shared vehicle driver include prior rentals of a shared vehicle by the shared vehicle driver.

15. The method of claim 13, wherein the shared vehicle driver profile is used to determine a parking maximum duration of the vehicle sharing parking space availability notification.

16. A method of managing parking for a vehicle sharing system, comprising the steps of:
confirming that a shared vehicle has departed from a vehicle sharing parking space;
determining a third-party reservation availability, wherein the third-party reservation availability indicates that a vehicle sharing parking space that was occupied by the shared vehicle will be available for a rental period;
determining whether the rental period of the third-party reservation availability is greater than a threshold period;
when it is determined that the rental period of the third-party reservation availability is greater than the threshold period, sending a vehicle sharing parking space availability notification to a third party;
monitoring the vehicle sharing parking space; and
reconciling usage of the vehicle sharing parking space between the shared vehicle and the third party.

17. A vehicle sharing system, comprising:
a shared vehicle;
a vehicle sharing parking space;
a reservation profile building tool configured to receive an active vehicle sharing reservation notification and build a reservation profile; and
a reservation management tool configured to determine a third-party reservation availability that indicates that the vehicle sharing parking space will be available for a rental period, send a vehicle sharing parking space availability notification to a third party so that the third party can use the vehicle sharing parking space during at least a part of the rental period of the shared vehicle, and receive a notification of use of the vehicle shared parking space during the rental period of the third-party reservation availability.

18. The system of claim 17, wherein the reservation profile building tool is further configured to monitor habits of a shared vehicle driver, develop a shared vehicle driver profile, and modify the reservation profile using the shared vehicle driver profile.

19. The system of claim 18, wherein the habits of the shared vehicle driver include prior rentals of a shared vehicle by the shared vehicle driver.
